(19) United States
(12) Patent Application Publication
(10) Pub. No.: US 2006/0075443 A1
(43) Pub. Date: Apr. 6, 2006

(54) Switching to a broadcast data stream

(76) Inventor: Wieland Peter Eckert, Fuerth (DE)

Correspondence Address: Lucent Technologies Inc.;Docket Administrator - Room 3J-219, 101 Crawfords Corner Road, Holmdel, NJ, 07733-3030, US

(21) Appl. No.: 10/950,787

(22) Filed: Sep. 27, 2004

(51) Int. Cl. H04N 7/173; H04N 7/16

(52) U.S. Cl. 725/97; 725/100; 725/131; 725/139; 725/151; 725/90

(57) ABSTRACT

A user terminal is provided with a program by starting transmission of a media stream representing the first part of the program over a dedicated connection specific to the user terminal at a time selected by the user but at a rate enabling the user terminal to switch seamlessly to receiving the rest of the program from a regular broadcast media stream.

### TECHNICAL FIELD

The present invention relates to data telecommunications and, in particular, to delivery of a media stream to a user terminal.

### BACKGROUND OF THE INVENTION

Two key features of digital media streams, such as video and/or audio programs, are the method of distribution and the time of delivery. The method of distribution can be by broadcast to multiple users, or transmission dedicated to an individual user on demand. As regards time of delivery, as shown in FIG. 1, traditionally a media stream, such as a television news program, is broadcast just once. If the user misses the scheduled broadcast time, then he or she simply misses the program.

Particularly for digital media streams that are relatively long, such as films, a strategy was developed, as shown in FIG. 2, of repeating transmission of the same media stream periodically. An example is a television station retransmitting a film every two hours. Digital television stations in particular have found this approach to be useful, but the user still has to wait for the next transmission of the media stream, if, for example, he has missed the beginning of the film he wanted to see.

A further approach was developed where media streams are transmitted more frequently than the length in time of the media stream transmission. This is illustrated in FIG. 3. An example is where periods between repetitions are acceptably short, such as, for example, every 20 minutes, for a film lasting an hour or two. This type of delivery is often called “near-on-demand” delivery. This approach is used by digital TV stations that specialize in film broadcasting.

From a user's point of view, ideally he would not want to have to wait for the media stream transmission to start at a scheduled time, but would rather have his request for the media stream responded to immediately by the media stream being transmitted to him immediately. This is known as “on-demand” streaming. This known approach is desirable for increased user satisfaction, but it has a major drawback that vastly increased transmission resources are required to provide each user with his own dedicated transmission.

### SUMMARY OF THE INVENTION

When considering the known systems, the inventor realized that, in those known systems, often either a user desiring a media stream had to wait until the media stream was next broadcast, or he was provided with his own individual media stream transmission which was costly in terms of network resources. The inventor realized that a system could be developed with neither of these disadvantages.

The inventor found a way to provide a user terminal with a program by starting transmission of a media stream representing the first part of the program over a dedicated connection specific to the user terminal at a time selected by the user, but at a rate enabling the user terminal to switch seamlessly to receiving the rest of the program from a regular broadcast media stream.

According to one illustrative embodiment, a method is provided for a user terminal to receive a program by the following steps. A first data stream is received over a dedicated connection at a first rate. Then a second data stream is received from a broadcast channel at a second rate. The first data stream represents a first part of the program and the second stream constituting the latter part of a broadcast transmission of the whole program. The first rate and second rate are different. Transfer from receiving the first stream to receiving the second stream is made at a time when the dedicated transmission and the broadcast transmission reach at least substantially the same point in the program. The received first stream and received second stream together represent, at least substantially, the whole program.

Using this method according to the principles of the invention, the user can be provided with an apparent “on-demand” service. Also, there is an advantage that a user does not receive the whole program via his own dedicated connection, so less network resources are required. In consequence, more users can be served with the apparent “on-demand” service.

### BRIEF DESCRIPTION OF THE DRAWINGS

An illustrative embodiment of the present invention will now be described by way of example and with reference to the drawings, in which:

FIG. 1 is a diagram illustrating a single broadcast of a media stream (prior art);

FIG. 2 is a diagram illustrating repeated broadcast of a media stream on a channel (prior art);

FIG. 3 is a diagram illustrating repeated broadcast of a media stream on different channels such that at any one time there are several media streams running (prior art);

FIG. 4 is a diagram illustrating transmission of a program according to the present invention where the user requests to start receiving the program later than when a scheduled broadcast starts;

FIG. 5 is a diagram illustrating transmission of a program according to the present invention where the user requests to start receiving the program earlier than when a scheduled broadcast starts; and

FIG. 6 is a block diagram illustrating apparatus according the present invention.

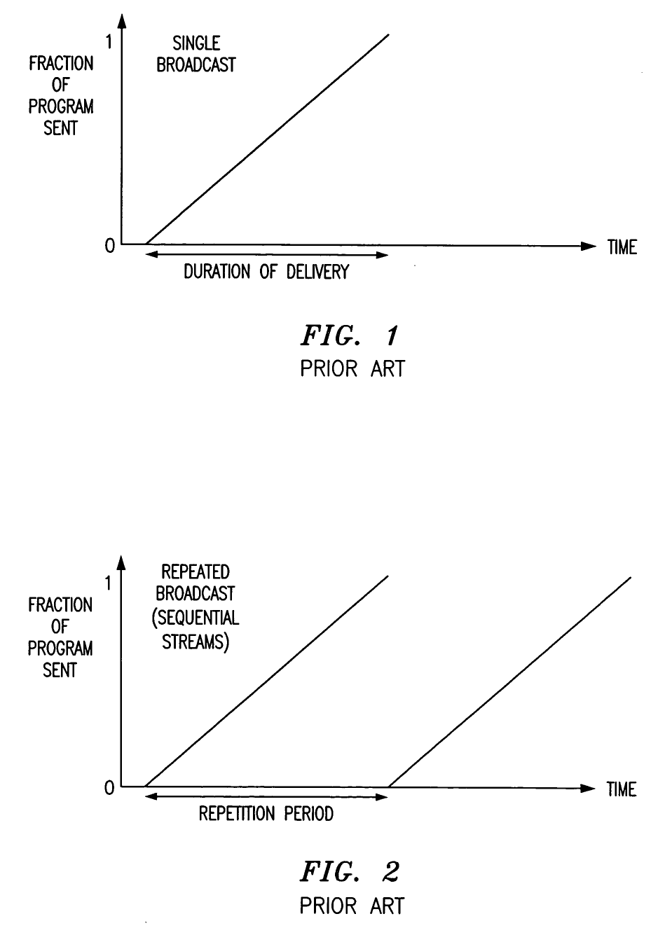

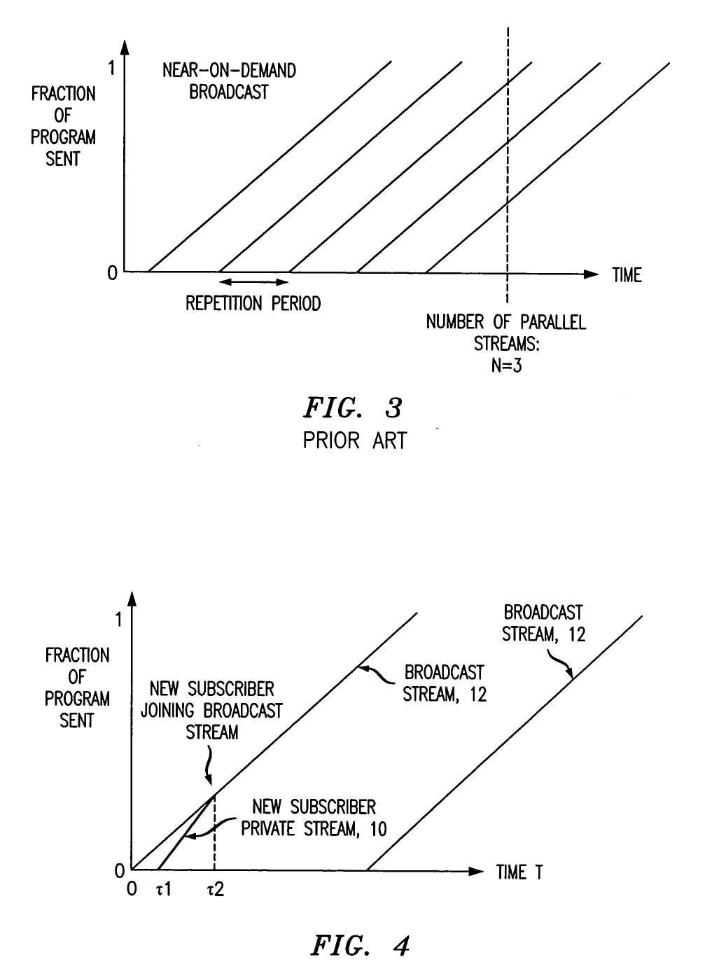

### DETAILED DESCRIPTION

An example is based on the repeated broadcast approach, where, as shown in FIG. 4, a media stream representing a program is broadcast repeatedly with a preset period between scheduled broadcasts 12.

Consider the case where a user wants to receive the media stream but has just missed the beginning. Specifically, as shown in FIG. 4, the media stream started at T=0. However the user could not be provided with the media stream before time point τ1. Accordingly, a dedicated transmission of the media stream representing the program is made to that user starting at time point τ1. Importantly, this dedicated media stream 10 has a rate of delivery which is faster than for the broadcast streams 12 themselves. For example, if the broadcast stream 12 is provided at a rate of X units of data per second, then the user's personal stream 10 is provided at a delivery rate increased by a factor of 1+α, where α is a fraction. The value of α is selected so as to be no more than a predetermined maximum αₘₐₓ. The predetermined maximum αₘₐₓ is set according to previously made psychological studies that determine the level of degradation of quality perceived by a user based on delivery rate of the media stream. Example values of αₘₐₓ are 0.1 or 0.05.

Knowing the initial time delay τ1 and the difference in delivery rate between the user's personal stream 10 and a broadcast stream 12, the point in time τ2 is calculated when both the user's personal stream and the closest in time broadcast stream will reach the same point in the media program. In other words, when the fraction of the program transmitted by both streams will be the same. At this point in time τ2, which is shown in FIG. 4, the user's personal media stream is stopped and the user terminal is directed to receive instead from time τ2 onwards, the remainder of the broadcast stream 12. The control signal directing the user terminal to switch from the private stream to a broadcast stream control signals can be embedded in the private media stream, or sent separately.

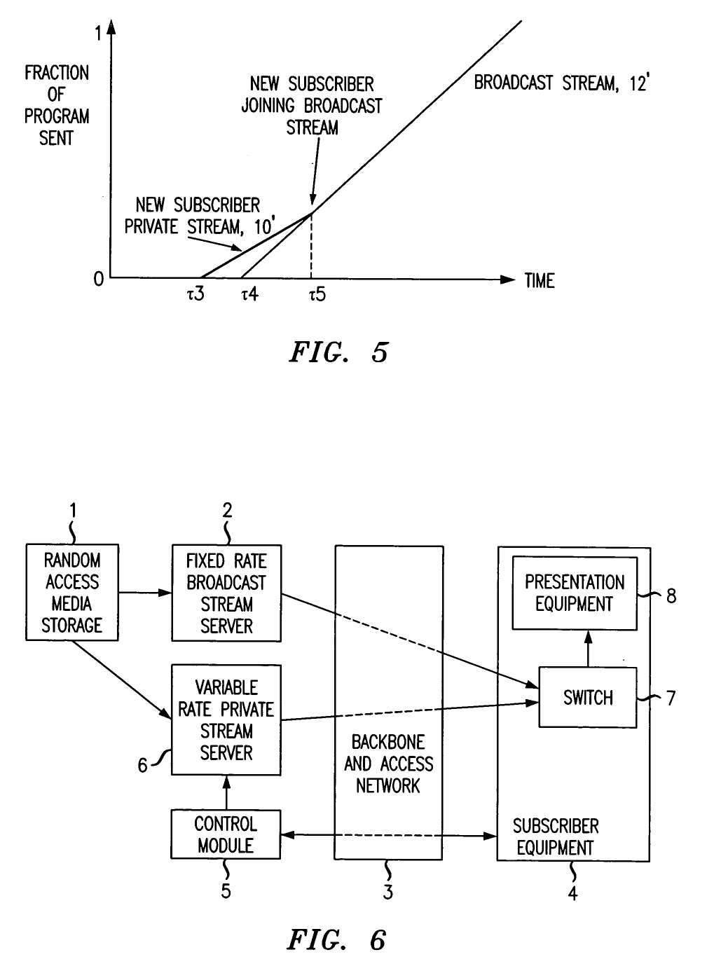

Alternatively, a new user may want to start receiving the media stream before the start of the next scheduled broadcast. For example, as shown in FIG. 5, the new user may wish to start receiving the media stream at time τ3, which is before the start time of the next scheduled broadcast τ4. Accordingly, the new user is transmitted to with a media stream 10′ for his reception only that starts at time τ3 but runs at a slower pace than the broadcast stream 12′ will. The rate of delivery of the personal stream 10′ is set to be less than that of the broadcast stream 12′ by a factor 1−α₂ where α₂ is capped to be no more than the predetermined maximum αₘₐₓ. As expected the next broadcast of the media stream starts at time τ4. At the point in time τ5 where both the personal stream 10′ and broadcast stream 12′ of the media stream reach the same point through the program, the user starts to receive instead the broadcast stream 12′ and the personal stream 10′ is stopped.

Apparatus in which this approach can be used will now be described. As shown in FIG. 6, the apparatus includes random access media storage 1 connected to two media stream servers 2 and 6. One is a broadcast stream server 2 operative to provide regularly repeated broadcasts of the media stream over the coverage area of the network. The other is a private stream server 6 operative to provide a transmission of the media stream dedicated to a particular user, in other words a private stream. The private stream server 6 is connected to a control module 5. The servers 2 and 6 and control module 5 are connected to a user terminal 4 via a network 3 consisting of a backbone network and an access network. In this example, the access network includes a cellular wireless network. The user terminal 4 includes a switch 7, the purpose of which is explained below, and presentation equipment 8, such as a video screen and loud speakers.

The media stream content, or in other words, the program, is stored in the random access storage device 1. The broadcast stream server 2, which operates at a fixed delivery rate, provides the repeated broadcast streams to the user terminal 4 via the backbone and access network 3. The broadcast streams are transmitted to all user terminals, one of which is shown for simplicity in FIG. 6. The user terminal 4 contains presentation equipment such as a video monitor, audio encoder/decoder and speakers. The user terminal 4 can be a mobile user terminal, such as a wireless handset.

Consider where a mobile user terminal 4 contacts the control module 5 with a request for transmission of the media stream at other than the scheduled time. This control module 5, which can be considered an “on-demand” control module, initiates a personal transmission of the media stream by instructing the variable rate stream server 6 to transmit a private stream to the particular user terminal 4 making the request. The control module 5 indicates to the variable rate stream server 6 what the rate of delivery is required. This rate of delivery could be, for example, a frame rate. The desired rate of delivery is within the limits 1−αₘₐₓ and 1+αₘₐₓ set by the control module 5. The variable rate stream server 6 transmits the private stream via the backbone and access network 3 to a particular user terminal 4 that requested the “on-demand” service. The control module 5 notifies that this user terminal 4 to receive on an appropriate channel the private stream. Accordingly, that user terminal 4 includes the switch 7 for selection of either the private stream or the broadcast stream for processing and output on the presentation equipment 8.

At the predetermined time calculated for transfer, the control module 5 sends a control signal notifying the user terminal 4 to switch from the private stream to the broadcast stream. Thereafter the user terminal continues to receive the media content, in other words the rest of the program, from the broadcast stream. The control module 5 at that time also instructs the variable rate stream server 6 to cease transmission of the private stream. Accordingly, the variable rate stream server's resources are freed up for use in response to a new request from another user for “on-demand” delivery of the media stream starting at other than a scheduled broadcast time.

The variable rate of media stream delivery can be achieved by a range of known methods. For example dropping frames periodically for faster delivery, periodically duplicating frames for slower delivery, or more elaborate methods of resampling, re-encoding, and/or trans-coding for either.

The delivery rate of the private stream can be variable whilst being sent to the user terminal. For example, when approaching the point of transfer from the private stream to the broadcast stream some time can be spent to gradually adjust the delivery rate of the private stream to that of the broadcast stream. This softens any discontinuity in the media stream to display rates that might be perceived by the user.

The speed up or slow down factor can be selected depending on a per user, or per user class, basis. Some users would be prepared to accept a faster or slower rate of private stream delivery than others. For example, a user of a higher quality of service class has a smaller value set for αₘₐₓ than a lower class user. In other words, less speed-up or slow down of a higher class user's private stream is permitted relative to the usual broadcast stream delivery rate. In consequence, the higher class user may have a private stream transmission for longer than a lower class user would get.

It will be noted that due to the cap on the rate of delivery increase or decrease due to αₘₐₓ, if the interval between scheduled broadcast starts is too long, there will be periods within those time intervals during which a user cannot start a program by having a dedicated media stream and yet be switched seamlessly to a scheduled broadcast during the program. This situation is avoided simply by having scheduled broadcasts repeated sufficiently.

The maximum faster delivery rate factor can be set to be different to the minimum delivery rate factor, for example where a user is less, or more, sensitive to a speeded up rather than a slowed down delivery rate.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method of a user terminal receiving a program, the method comprising:
receiving a first data stream over a dedicated connection at a first rate; and
then receiving a second data stream from a broadcast channel at a second rate,
the first data stream representing a first part of the program and the second stream constituting the latter part of a broadcast transmission of the whole program,
the first rate and second rate being different,
transfer from receiving the first stream to receiving the second stream being made at a time when the dedicated transmission and the broadcast transmission reach at least substantially the same point in the program such that the received first stream and received second stream together represent, at least substantially, the whole program.

2. A method according to claim 1, wherein transmission of the first stream over the dedicated connection starts after the broadcast transmission of the program starts, said first rate being faster than said second rate so that there is a time when substantially the same point in the program is reached.

3. A method according to claim 1, wherein transmission of the first stream over the dedicated connection starts before the broadcast transmission of the program starts, said first rate being slower than said second rate so that there is a time when substantially the same point in the program is reached.

4. A method according to claim 1, wherein the program comprises audio and/or video.

5. A method according to claim 1, wherein the transfer is undertaken upon receipt of a control signal received via the dedicated connection.

6. A method according to claim 1, wherein the first rate is selected to be different from the second rate by no more than a predetermined maximum difference so as to keep user-perceived quality within acceptable limits.

7. A method according to claim 6, wherein the maximum difference is greater for a user subscribing to a lower quality of service than for a user subscribing to a higher quality of service.

8. A telecommunications apparatus comprising first and second servers, a controller, and a distribution network,
the first server being operative to provide at a first rate a first data stream representing the first part of a program for transmission to a user terminal by a dedicated connection through the network,
the second server being operative to provide at a second rate a second data stream representing the whole program for broadcast by the network,
the first rate being different from the second rate and being selected by the controller dependent upon the difference in start times of the dedicated transmission and the broadcast transmission such that a time is reached when the dedicated transmission and the broadcast transmission of the program reach, at least substantially, the same point in the program.

9. A telecommunications apparatus according to claim 8, wherein the dedicated transmission is started upon receipt by the controller of a request for transmission of the program to start at other than a broadcast start time.

10. A user terminal configured to receive a program by
receiving a first data stream over a dedicated connection at a first rate,
then receiving a second data stream from a broadcast channel at a second rate,
the first data stream representing a first part of the program and the second stream constituting the latter part of a broadcast transmission of the whole program,
the first rate and second rate being different,
the user terminal comprising a switch configured to transfer the user terminal from receiving the first stream to receiving the second stream at a time when the dedicated transmission and the broadcast transmission reach at least substantially the same point in the program such that the received first stream and received second stream together represent, at least substantially, the whole program.

11. A user terminal according to claim 10, wherein the switch operates dependent upon a control signal received via the dedicated connection.
